(19) United States
(12) Patent Application Publication
(10) Pub. No.: US 2020/0224542 A1
(43) Pub. Date: Jul. 16, 2020

(54) FIR TREE ROOT FOR A BLADED DISC

(71) Applicant: ROLLS-ROYCE plc, London (GB)

(72) Inventors: Jack R. TILLEY, Burton (GB); Farida IBRAHIM.A, Derby (GB); Theodoros PANAGIOTIDIS, Derby (GB); Johannes-Paulus OLUFEAGBA, Birmingham (GB)

(73) Assignee: ROLLS-ROYCE plc, London (GB)

(21) Appl. No.: 16/719,336

(22) Filed: Dec. 18, 2019

(30) Foreign Application Priority Data
Jan. 14, 2019 (GR) 20190100027
Mar. 5, 2019 (GB) 1902941.2

(51) Int. Cl. F01D 5/30; F01D 5/02

(52) U.S. Cl. CPC F01D 5/30; F05D 2240/60; F05D 2220/323; F01D 5/021

(57) ABSTRACT

A bladed disc for a turbine engine has disc and blade portions. The disc portion extends in a radial direction from the turbine engine central axis and has slots around its circumference with an inverse fir tree profile. The blade portion has aerofoil and root sections. The root section is configured to have a fir tree profile. The blade portion engages with a slot on the disc portion circumference with the fir tree profile of the root section of the blade portion engaging with the inverse fir tree profile of the slot within the disc portion. The fir tree profile of the root section of the blade portion and the inverse fir tree profile of the slot of the disc portion are curved. The bladed disc has a clearance plate mounted on at least one of the blades, the clearance plate extending across the slot on the disc portion.

### CROSS-REFERENCE TO RELATED APPLICATIONS

This specification is based upon and claims the benefit of priority from Greek patent application GR 20190100027 filed on Jan. 14, 2019 and United Kingdom patent application GB 1902941.2 filed on Mar. 5, 2019, and the entire contents of both are incorporated herein by reference.

### BACKGROUND

### Field of the Disclosure

The present disclosure relates to fir trees for use in turbine engines.

### Description of the Related Art

A known method of connecting a turbine and/or a compressor blade to their mounting disc is the use of cooperating fir tree profiles. Such profiles are frusto-conical in shape with the blade being provided with a series of protrusions that engage with respective indentations that are machined into the profile of the disc itself. This can be from a single protrusion in the case of a dovetail to having multiple protrusions. These fir tree profiles are strong enough to withstand the radial centrifugal forces that apply outwardly on the blade as it is rotating during operation. Due to the shape of the profiles, the flanks of the fir tree profiles that face away from the central axis of the engine support the blades against radially outward movement; these can be regarded as loaded flanks. Opposing these are flanks that are unloaded as they do not support any significant radial force in operation. The profiles of the flanks are provided with transition regions, which are alternately convex surfaces—which are usually, but not always, arcuate and are referred to as fillets—and concave surfaces—that are usually, but not always, arcuate and are commonly known as corners. It is the fillet regions that experience high concentrations of stress. The use of fir tree profiles as a retention method works sufficiently when the disc is rotating at high speeds. However, at low speeds the blades are able to move laterally along the disc and as such require another means for them to be retained in place.

To overcome the issue of low speed blade retention lock plates are known to be used in the prior art to keep the blade in place when operating within these conditions. Lock plates are typically made of steel or titanium alloy and are pre bent to be able to fit into the gap between the blade and the disc. Once they are in this position they are then rotated to ensure the correct positioning before being forced, usually by hammering, into position, as discussed in European Patent EP 2808489 B1. Typically the lock plates are positioned between the blade and the disc to provide the necessary retention. The problem with the use of lock plates is that they increase the complexity of the blade component, which ultimately affects performance as well as the assembly and disassembly process of the discs. One issue is that due to the location of the lock plates they can only be removed from the rear; this leads to a substantially longer disassembly process, which affects maintenance costs. Removal of the lock plate is performed using a destructive process that also risks damaging the disc. As such there is a need to overcome the limitations of using a lock plate whilst still being able to retain the blades in place during low speed operation.

### SUMMARY OF THE DISCLOSURE

According to a first aspect there is provided a bladed disc for a turbine engine, the bladed disc comprising: a disc portion and a blade portion; the disc portion extends in a radial direction from a central axis of the turbine engine and comprises a plurality of slots around its circumference, the slots being provided with an inverse fir tree profile; and the blade portion comprises an aerofoil section and a root section, the root section being configured to have a fir tree profile; wherein the blade portion engages with a slot on the circumference of the disc portion with the fir tree profile of the root section of the blade portion engaging with the inverse fir tree profile of the slot within the disc portion; the fir tree profile of the root section of the blade portion and the inverse fir tree profile of the slot of the disc portion are curved; and the bladed disc further comprises a clearance plate mounted on at least one of the blades, the clearance plate extending across the slot on the disc portion.

The advantage of this design over the prior art is that due to the curvature of the blades any motion of the blades during low speed movement will result in the blades self-retaining. This is because any movement in the position of the blades will result in engagement with neighbouring blades, which will maintain the blades in position. This configuration removes the requirements for a lock plate to maintain the disc in position. This is beneficial as it also makes the assembly and disassembly more straightforward and can allow the blade to be removed from either side of the disc.

The fir tree profile of the root section of the blade portion and the inverse fir tree profile of the slot of the disc portion may be curved in the radial direction.

The blade portion may feature a hilt at an interface between the root section and the aerofoil section, wherein the hilt section extends beyond the blade portion along the axis of the engine.

Clearance plates may be provided on every blade and slot pairing and extend around the disc.

Two neighbouring blades may be provided with clearance plates and an engagement feature is provided between the two clearance plates to form an interlocking fit.

The radial curvature of the fir tree profiles may be towards the central axis of the engine.

The radial curvature may be convex.

The radial curvature may be concave.

The curvature angle may be greater than 0° but less than or equal to 180°.

The curvature angle may be 0° to 90°.

The fir tree profile on the root section of the blade portion may have three projections and the slot on the disc portion features three respective indentations.

The fir tree profile may be a dovetail profile.

According to a second aspect there is provided a gas turbine engine for an aircraft, the gas turbine engine comprising: an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft, wherein the gas turbine engine incorporates the bladed disc of any preceding claim.

The turbine may be a first turbine, the compressor may be a first compressor, and the core shaft is a first core shaft; the engine core may further comprise a second turbine, a second compressor, and a second core shaft connecting the second turbine to the second compressor; and the second turbine, second compressor, and second core shaft may be arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

The gearbox is a reduction gearbox (in that the output to the fan is a lower rotational rate than the input from the core shaft). Any type of gearbox may be used. For example, the gearbox may be a “planetary” or “star” gearbox, as described in more detail elsewhere herein. The gearbox may have any desired reduction ratio (defined as the rotational speed of the input shaft divided by the rotational speed of the output shaft), for example greater than 2.5, for example in the range of from 3 to 4.2, for example on the order of or at least 3, 3.1, 3.2, 3.3, 3.4, 3.5, 3.6, 3.7, 3.8, 3.9, 4, 4.1 or 4.2. The gear ratio may be, for example, between any two of the values in the previous sentence. A higher gear ratio may be more suited to “planetary” style gearbox. In some arrangements, the gear ratio may be outside these ranges.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being) Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, 17, 17.5, 18, 18.5, 19, 19.5 or 20. The bypass ratio may be in an inclusive range bounded by any two of the values in the previous sentence (i.e. the values may form upper or lower bounds). The bypass duct may be substantially annular. The bypass duct may be radially outside the engine core. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15° C. (ambient pressure 101.3 kPa, temperature 30° C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 14, 16, 18, 20, 22, 24 or 26 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 is a prior art example of a turbine blade featuring a straight fir tree profile;

FIG. 5 shows an example of a turbine blade featuring a curved fir tree profile of a blade portion of a bladed disc of the present disclosure;

FIG. 6 shows a corresponding fir tree profile on the mounting disc portion of a bladed disc of the present disclosure, which is used for mounting the blade portion of FIG. 3;

FIG. 7 shows the interaction between neighbouring blades of when displacement of one of the blades occurs according to the present disclosure;

FIG. 8 presents a first embodiment of an additional clearance plate that can be added to the blade to maintain the blade in position;

FIG. 9 presents a second embodiment of an alternative clearance mechanism featuring a locking clip between them to maintain the blades in position.

### DETAILED DESCRIPTION OF THE DISCLOSURE

Aspects and embodiments of the present disclosure will now be discussed with reference to the accompanying drawings. Further aspects and embodiments will be appreciated by those skilled in the art.

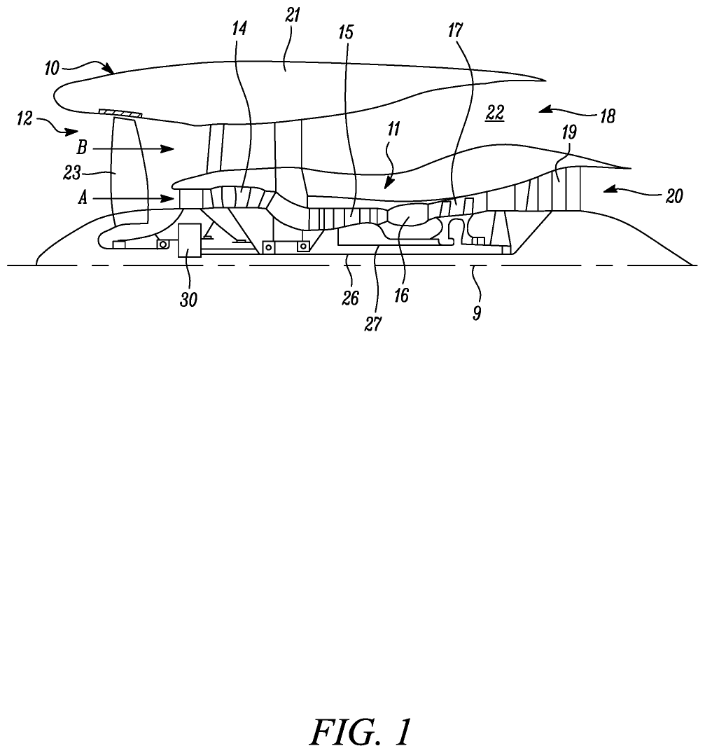

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

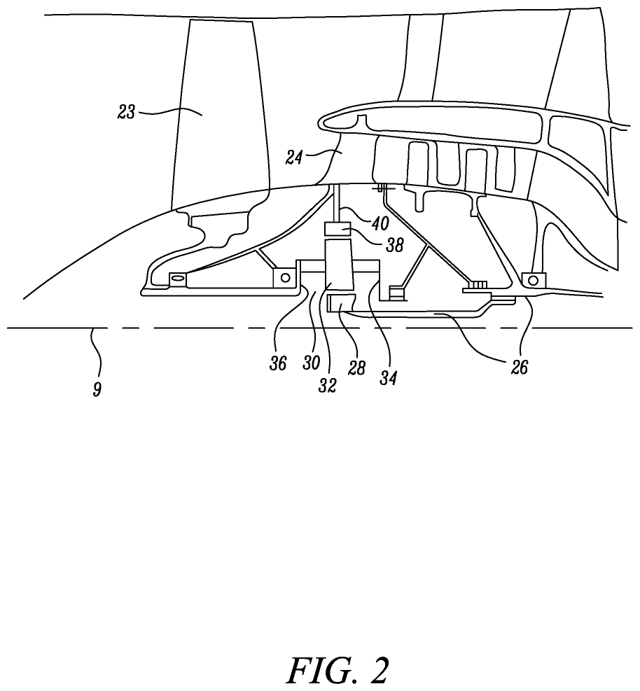

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

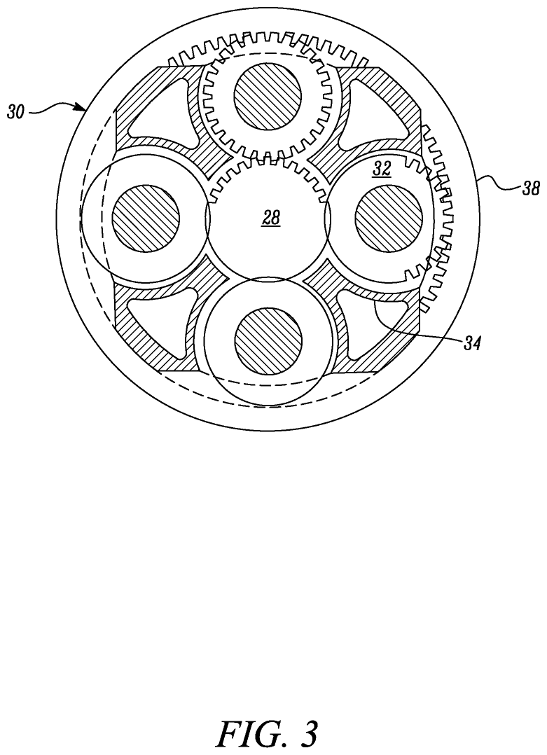

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

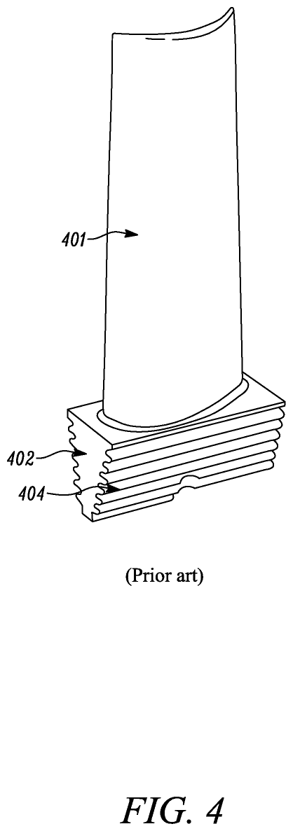

A prior art example of a blade for a compressor or turbine is shown in FIG. 4. The blade is shown having an aerofoil section 401 comprising a pressure surface, a suction surface and a root section 402. The root section has fir tree projections 404 machined into the surface in order to produce a series of engagement features for interlinking with a receiving slot on the disc to which the blade is to be mounted. In this prior art example the projections continue linearly along the width of the root. As discussed above there is a requirement that when the blade is mounted on the disc there is a need for the use of a lock plate, which is required to retain the blade in position at low speeds. This prevents the lateral movement of the blade and the ability of the blade to come off the mounting disc. The presence of this lock plate, however, increases the complexity and the mass of the bladed disc when assembled. As such, the use of lock plates, which are placed between the disc and blades, introduces a high level of complexity to the component which affects the assembly and disassembly procedures. As such the maintenance of the bladed discs becomes much more challenging. Due to their location the lock plates can only be liberated from the rear; this is a process that requires a long disassembly routine. The extraction of the blade currently utilises a destructive process which has the potential to also damage the turbine or compressor disc to which the blades are attached.

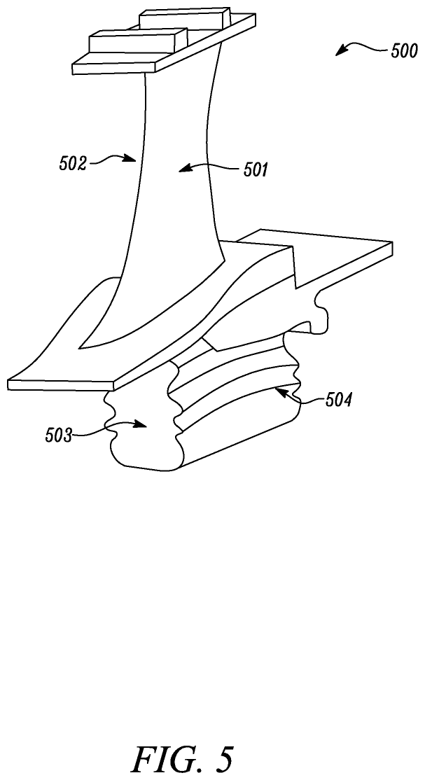

A blade 500 of a compressor or turbine of a turbine engine of the present invention is presented in FIG. 5. In this the blade has the pressure surface 501, suction surface 502 and the root section 503 featuring the fir tree projections 504. However, in this case rather than the projections extending linearly across the width of the root, they instead feature a curve along their length. The curve is in the radial direction, from the centre of the mounting disc to which the blade is mounted, and extends in a plane perpendicular to the plane of the disc. In the example shown in FIG. 5 the curvature is shown to be extending radially outwardly i.e. towards the distal end of a blade. However, the invention is not limited to such an embodiment and the curvature maybe radially inward or towards the proximal end of blade.

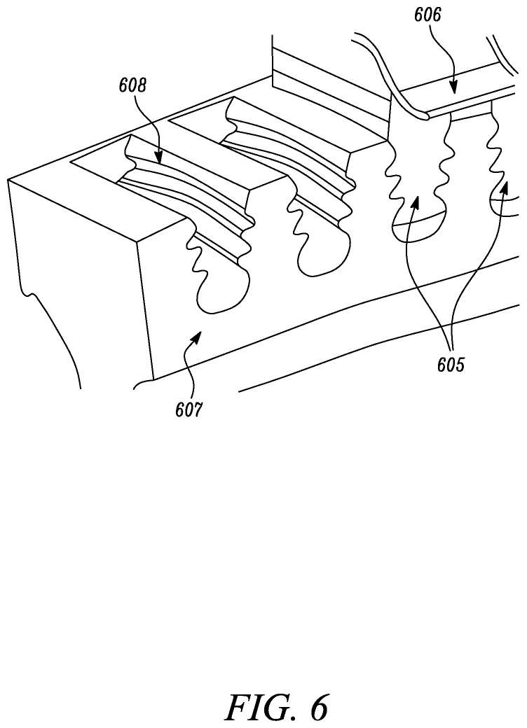

In addition to the blade root featuring a curve, the disc also requires a curve to support the blade for mounting. This is shown in FIG. 6 in which a partial section of the disc 607 demonstrates the curvature of the profile when applied to the disc. The disc has the reverse features 608 to the blade with the profile featuring sections that have been machined away to provide the slots for the projections on the blade to engaged with. These cut away sections continue along the circumference of the disc, such that the blades 605 can be evenly distributed around the disc. The corresponding machining of the blade and disc allows for simple insertion of the blade into the slot within the disc.

Due to the curved profile of the fir tree any axial movement of the blade will translate to a change in the radial position of the blade. This radial movement will result in interference (or contact) with the neighbouring blades at the edge of their hilts 606, which will act to maintain the blade in position. This is because instead of sliding straight off the disc, the blades instead have to follow the curved path of the fir tree in order to be released. Consequently, this brings them into contact with the neighbouring blade. By bringing one blade into another the blades will, if they have enough momentum, continue to be displaced until they meet a stationary blade on the disc. This is because the motion of the blades will slide into a neighbouring blade around the circumference of the disc. This is therefore a self-locking mechanism in which the differing motion of the blades will ensure that they are retained in position. This offers an improved design that simplifies the disc and blade interaction. The blades and the discs can have the curvature in either direction.

The number of projections on the fir tree can be any suitable number. This could be one in the case of a dovetail. Similarly, it could for example between 3-5 projections on each blade with the associated indentations on the disc. With respect to the centreline of the disc, the fir tree curvature can be convex or concave with a curvature angle greater than zero degrees and less than or equal to 180 degrees. The curvature of the fir tree corresponds to an arc section. In this, the angle of curvature e represents the arc angle corresponding to an arc length equal to the length curvature of the fir tree on the disc or blade. In certain cases the arc may have a radius equivalent to the disc, however, it is not limited to this. As such, the radius of the circle defining the arc angle can be varied to any suitable value to provide a curve. This angle must be angle greater than zero degrees and less than 180 degrees. In particular the curvature may be 0° to 90°. Furthermore, between 20° to 40°. The intent of this curve is to oppose the resultant component of centrifugal forces and the axial forces.

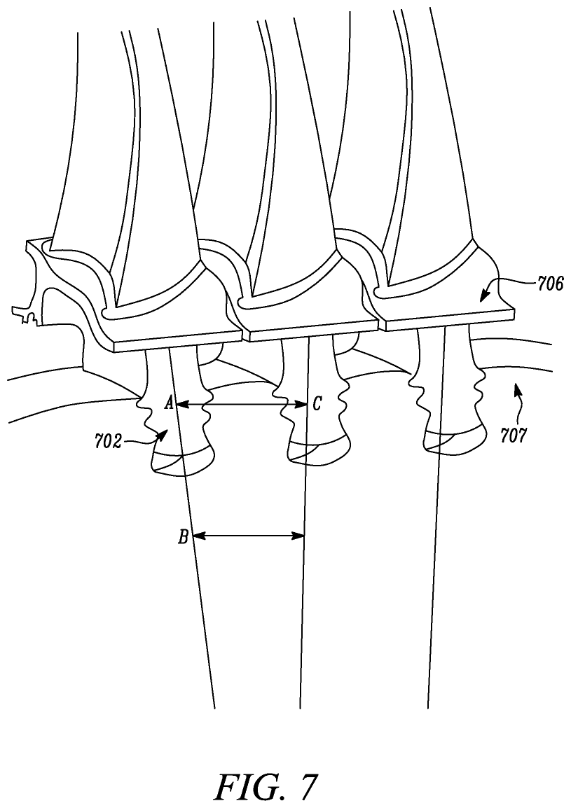

The interference between the displaced blades is shown in FIG. 7 where it can be seen that a hilt 706 at the top of the root section 702 contact with the same part of a neighbouring blade. As the blades are surrounding the disc 707 the effect of the radial displacement is restricted to this region as each of the blades are held in position by each of the neighbouring blades around the disc. The advantage of this design is that it eliminates the need for using of lock plates in the turbine to retain the turbine or compressor blades in place during operation, thus potentially reducing the overall weight of the blade and disc assembly. This design will allow for the blades to be removed from both the front and rear sides of the disc as required. Such a configuration allows for the assembly and disassembly routine to be tailored for the specific disc. If there is no need for the requirements for the blade to be removed from a specific side then a stopper can be incorporated into the disc to ensure that the blades can only be fitted or removed in a particular direction. The improved design thus eliminates the load that lock plates exert on the blades. This removal of the lock plates is beneficial in reducing the wear on the components due to this reduction in strain. The removal of the lock plates also eliminates a potential buckling failure mode for the component, which will improve the reliability of the component.

As shown in FIG. 7 if the blade starts to move axially a change in the position along the radius from point A towards point B results. This also results in reduction in the horizontal distance from A to C between the blades due to the curvature of the fir tree profiles on the disc and blade. This is because the movement forces the blade to move down a radial line as shown in the figure and which is angled with respect to the neighbouring blade. As such, even if all the blades move in the same direction the continuous radius of the hilts 706 will be reduced, which will result in all of the hilts contacting each other and thus keeping themselves in position. If it is only the movement of a single blade then this will just force it into the neighbouring two blades, which themselves could potentially move. However, this movement will then continue along the adjacent blades, but as they are in a disc they will eventually all come together and lock into position.

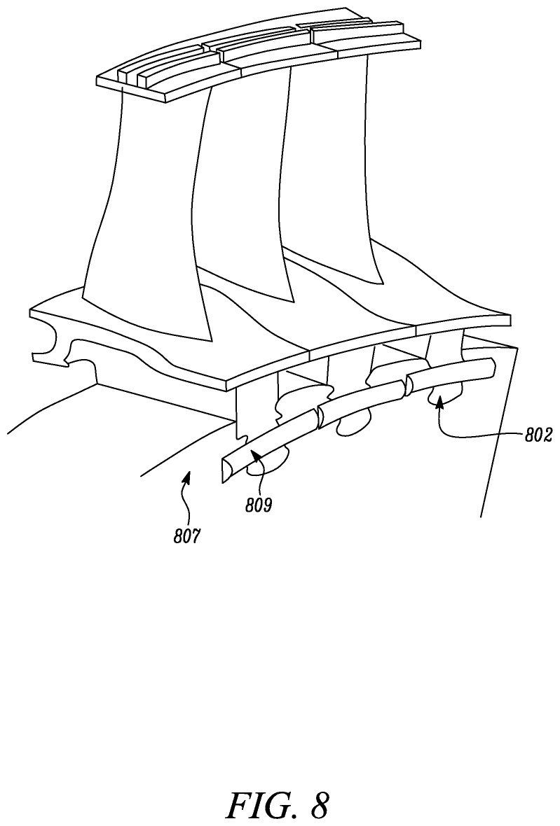

If required a locking mechanism is added to further enhance the security of the blades. This can be added to the blade design across the fir tree and applied to all of the blades on the disc, such that all the other blades are locked in place using this feature. This locking mechanism could be further enhanced by adding features on the blade to control the clearance. The front or rear of the blade is one such location where the additional clearance feature can be placed as shown in FIG. 8. This feature consists of a clearance plate 809 attached to the face of the blade root section 802 and the disc 807 and if attached on one side of the disc will prevent movement of the blade in the direction of the opposite side to the plate. Thus, the blade is prevented form moving by interference with the disc and/or the neighbouring blade or plate. The plate can be formed during the casting or forging of the blades. Alternatively it could be attached or mounted to the blade at a later stage by any suitable connection means; this may include brazing the plate onto the blade. These clearance plates 809 will also allow for tighter clearances for the component as it located further away from the hot zone of the aerofoil in the case of a turbine blade. The benefit of a tighter clearance is that it will reduce the axial motion of the blade. The locking mechanism itself can consist of at least one of these clearance plates 809. These plates may be designed such that when assembled with the blades on the disc they are in close proximity of their neighbour, or may be designed to be slightly greater than the width of the blade, so that the can engage with the disc. Alternatively they may only extend to one side of the blade, and so only engage with the disc at that point. Alternatively, the disc could feature the locking feature. This could be a blanking plate, or feature a projection or a pin to stop the axial movement of the blade. The locking mechanism on the blade and the disc can be used either separately or in conjunction with each other.

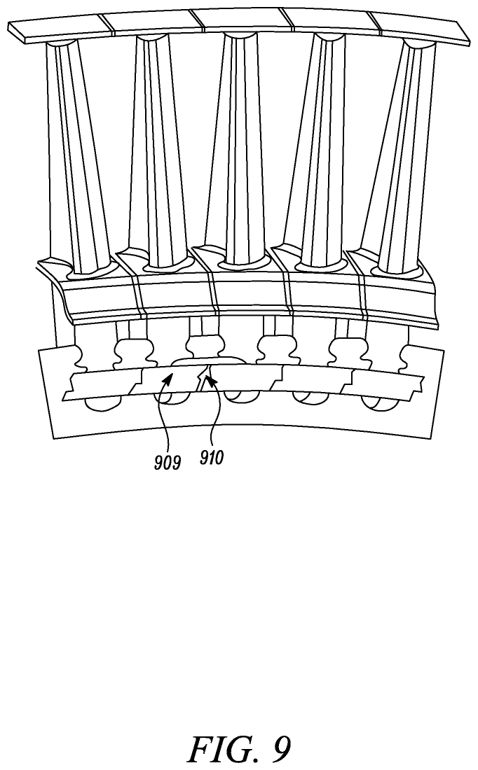

The presence of a locking blade will be required for a complete retention of the blades. This can be done as shown in FIG. 9. Here, clearance plates 909 are added to all of the blades and extend such that they are in close proximity to the neighbouring blades clearance plates; thus having a tighter clearance. This may be to either the front or rear of each of the blades. These clearance plates may include edges that follow along the radial line or can be shaped to produce an interlocking fit. The last blade to be inserted, however, has a smaller clearance plate in order to allow it to be slid in; otherwise it would clash with the clearance plates on the neighbouring blades. Consequently, this clearance plate is configured to have a larger gap in operation between it and the neighbouring clearance plate. Into this gap can be inserted a locking clip 910, which prevents movement of the blades in the axial direction in which the clearance plates are added. This locking clip engages with the two neighbouring clearance plates and locks them together. This locking clip could for example be a “T-key bar” As such this will ensure that because of the curvature of the blades that if two of them are locked in position that no blades are able to come off the disc when operating at low speeds. As discussed, the locking features may not be just be limited to a single pair of clearance plates but may be distributed around the disc. As the clearance plates are not interlocking even if they are provided with a locking clip they do not have to be removed destructively. As such this can limit the damage caused to the blades and the disc resulting from the removal of the engagement feature over the use of a locking plate. Alternative means of coupling two of the clearance plates together using a locking clip will be apparent to those skilled in the art. For example a fastening or clipping means could be used to ensure the engagement, or they could be engaged by frictional means or by adhesive or physical coupling.

The blades may be inserted at an angle relative to the plane of the blade. In this instance the root of the blade is angled relative to the hilt and the blade; this means that the blades remain at their standard angle whilst the root to which they are attached are angled. This angling of the root may allow for easier insertion of the blade into the disc. The reason for this is that the hilts are all parallel to each other and minimises interference enough to allow for the assembly of the full ring. The angle of the slot for the in the disc will match the angle of the hilt.

The curved fir tree can be manufactured with precision electrochemical machining (pECM); however, five-axis milling, electro-discharge machining and additive layer manufacturing methods are potential alternative solutions. Precision electrochemical machining is an electrochemical erosion process utilising oscillating electrodes with a regulated working gap. The process applies a pulsed direct current pulse between the electrode and the workpiece. This workpiece then can dissolve anodically with the geometry of the electrode; this allows for highly complex geometrical shapes to be machined accurately in a repeatable way. As such it is a process that is particularly suited to manufacturing these complex shapes of the curved fir trees on both the blade and the disc. Electric discharge machining is a known machining process in which the fir tree is machined by spark erosion resulting from an electric discharge between a wire and the blade. This process can allow for accurate control when producing the fir tree. 5-axis machining utilises modern computer numerical controls (CNC) to perform this accurate machining of the component. 5-axis machines allow for greater conformity of the final component as either the workpiece—the component to be machined—or the tooling head can be moved along 5 different axes simultaneously. These movement axes are the standard X, Y and Z axis, as well as two rotational axes: the A-axis, which rotates around the X axis; and a C-axis which rotates around the Z-axis. This movement of the workpiece and of the tooling enables the machining of highly complex components such as that of the curved fir trees. Consequently by employing these modern manufacturing techniques allows for the accurate control of the mechanical surfaces which are required for the high tolerance needed to produce these components.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A bladed disc for a turbine engine, the bladed disc comprising:
a disc portion and a blade portion;
the disc portion extends in a radial direction from a central axis of the turbine engine and comprises a plurality of slots around its circumference, the slots being provided with an inverse fir tree profile; and
the blade portion comprises an aerofoil section and a root section, the root section being configured to have a fir tree profile;
wherein the blade portion engages with a slot on the circumference of the disc portion with the fir tree profile of the root section of the blade portion engaging with the inverse fir tree profile of the slot within the disc portion; the fir tree profile of the root section of the blade portion and the inverse fir tree profile of the slot of the disc portion are curved; and the bladed disc further comprises a clearance plate mounted on at least one of the blades, the clearance plate extending across the slot on the disc portion.

2. The bladed disc as claimed in claim 1, wherein clearance plates are provided on every blade and slot pairing and extend around the disc.

3. The bladed disc as claimed in claim 1, wherein two neighbouring blades are provided with clearance plates and an engagement feature is provided between the two clearance plates to form an interlocking fit.

4. The bladed disc as claimed in claim 1, wherein the fir tree profile of the root section of the blade portion and the inverse fir tree profile of the slot of the disc portion are curved in the radial direction.

5. The bladed disc as claimed in claim 4, wherein the blade portion features a hilt at an interface between the root section and the aerofoil section, wherein the hilt section extends beyond the blade portion along the axis of the engine.

6. The bladed disc as claimed in claim 1, wherein the radial curvature of the fir tree profiles is towards the central axis of the engine.

7. The bladed disc as claimed in claim 1, wherein the radial curvature is convex.

8. The bladed disc as claimed in claim 1, wherein the radial curvature is concave.

9. The bladed disc as claimed in claim 7, wherein the curvature angle is greater than 0° but less than 180°.

10. The bladed disc as claimed in claim 9, wherein the curvature angle is 0° to 90°.

11. The bladed disc as claimed in claim 1, wherein the fir tree profile on the root section of the blade portion features three projections and the slot on the disc portion features three respective indentations.

12. A gas turbine engine for an aircraft, the gas turbine engine comprising: an engine core comprising a turbine, a compressor, and a core shaft connecting the turbine to the compressor; a fan located upstream of the engine core, the fan comprising a plurality of fan blades; and a gearbox that receives an input from the core shaft and outputs drive to the fan so as to drive the fan at a lower rotational speed than the core shaft, wherein the gas turbine engine incorporates the bladed disc of claim 1.

13. The gas turbine engine as claimed in claim 12, wherein: the turbine is a first turbine, the compressor is a first compressor, and the core shaft is a first core shaft; the engine core further comprises a second turbine, a second compressor, and a second core shaft connecting the second turbine to the second compressor; and the second turbine, second compressor, and second core shaft are arranged to rotate at a higher rotational speed than the first core shaft.
